(19) United States
(12) Patent Application Publication
(10) Pub. No.: US 2024/0373352 A1
(43) Pub. Date: Nov. 7, 2024

(54) FRAMEWORK FOR MULTI-AP COORDINATED TWT

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/641,040

(22) Filed: Apr. 19, 2024

Related U.S. Application Data
(60) Provisional application No. 63/464,429, filed on May 5, 2023.

(51) Int. Cl. H04W 52/02

(52) U.S. Cl. CPC H04W 52/0216

(57) ABSTRACT

Methods and apparatuses for a framework for coordinated TWT (C-TWT). A method of wireless communication performed by a first access point (AP) comprises: receiving an indication from a first station (STA) associated with the first AP indicating that the first STA is experiencing overlapping basic service set (OBSS) interference associated with a second AP, wherein the first AP controls a first basis service set (BSS) and the second AP controls a second BSS; based on the indication, sending a target wake time (TWT) coordination request to the second AP for coordinating a TWT between the first AP and the second AP; and performing a coordinated TWT (C-TWT) procedure with the second AP for reducing the OBSS interference associated with the second AP.

### CROSS-REFERENCE TO RELATED APPLICATION(S) AND CLAIM OF PRIORITY

This application claims priority under 35 U.S.C. § 119 (e) to U.S. Provisional Patent Application No. 63/464,429 filed on May 5, 2023, which is hereby incorporated by reference in its entirety.

### TECHNICAL FIELD

This disclosure relates generally to target wake time (TWT) in wireless communications systems, and more particularly to a framework for coordinated TWT (C-TWT).

### BACKGROUND

Wireless local area network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Target wake time (TWT) is an important feature for power management in wireless fidelity (Wi-Fi) networks, which was developed by IEEE 802.11ah and later adopted and modified into IEEE 802.11ax. TWT allows an access point (AP) to manage activity in the basic service set (BSS) in order to minimize contention between stations (STAs) and to reduce the required amount of time that a STA utilizing a power management mode needs to be awake. This is achieved by allocating STAs to operate at nonoverlapping times and/or frequencies, and concentrate the frame exchange sequences in predefined service periods. With TWT operation, it suffices for an STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any physical layer protocol data unit (PPDU) format supported by the pair of STAs that have established the TWT agreement corresponding to that TWT SP, including high-efficiency multi-user (HE MU) PPDU, HE trigger-based (TB) PPDU, etc.

### SUMMARY

Embodiments of the present disclosure provide methods and apparatuses for a framework for C-TWT.

In one embodiment, a method of wireless communication performed by a first AP comprises: receiving an indication from a first STA associated with the first AP indicating that the first STA is experiencing overlapping basic service set (OBSS) interference associated with a second AP, wherein the first AP controls a first basis service set (BSS) and the second AP controls a second BSS; based on the indication, sending a TWT coordination request to the second AP for coordinating a TWT between the first AP and the second AP; and performing a C-TWT procedure with the second AP for reducing the OBSS interference associated with the second AP.

In another embodiment, a first AP comprises a transceiver, and a processor operably coupled to the transceiver. The processor is configured to: receive an indication from a first STA associated with the first AP indicating that the first STA is experiencing OBSS interference associated with a second AP, wherein the first AP controls a first BSS and the second AP controls a second BSS; based on the indication, send a TWT coordination request to the second AP for coordinating a TWT between the first AP and the second AP; and perform a C-TWT procedure with the second AP for reducing the OBSS interference associated with the second AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of a Type-I architecture for C-TWT negotiation according to various embodiments of the present disclosure;

FIG. 4 illustrates an example of a Type-II architecture for C-TWT negotiation according to various embodiments of the present disclosure;

FIG. 5 illustrates an example of a scenario for Mode-1 TWT-based multiple-AP coordination according to various embodiments of the present disclosure;

FIG. 6 illustrates an example of a scenario for Mode-2 TWT-based multiple-AP coordination according to various embodiments of the present disclosure; and

FIG. 7 illustrates a flow diagram of an example of a method for wireless communication performed by an access point (AP) device according to embodiments of the present disclosure.

### DETAILED DESCRIPTION

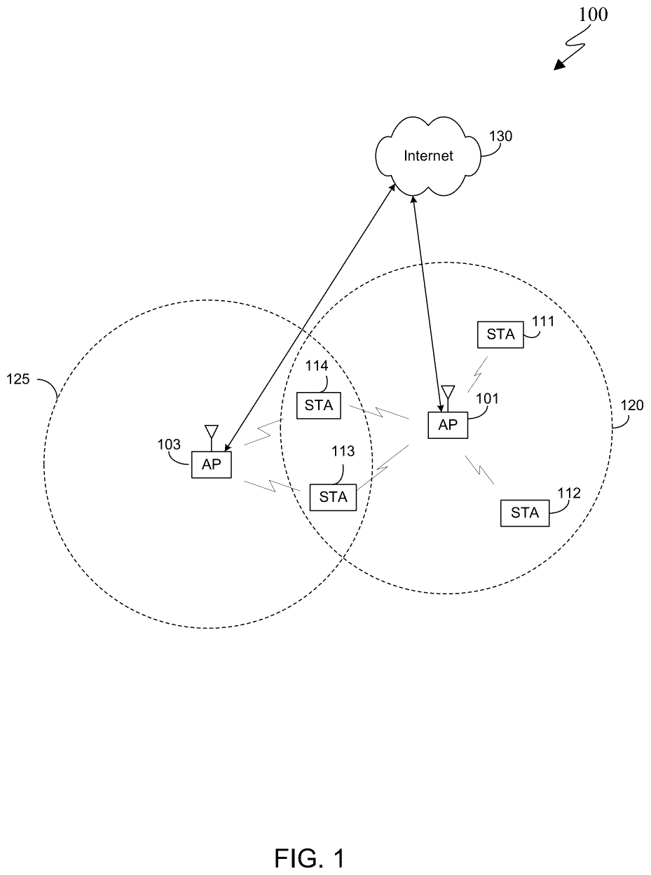

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE std. P802.11be-D1.3 “Part 11: Wireless LAN Medium Access Control (MAC) and Physical Layer (PHY) Specifications—Amendment 8: Enhancements for extremely high throughput (EHT)”.

Embodiments of the present disclosure recognize that there can be multiple ways to perform TWT-based multi-AP (MAP) coordination. However, currently, there is no mechanism to integrate different forms of TWT-based MAP coordination. A generalized framework for coordinated TWT (C-TWT) is missing.

Accordingly, embodiments of the present disclosure provide mechanisms for a framework for TWT-based MAP coordination.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating a framework for C-TWT. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

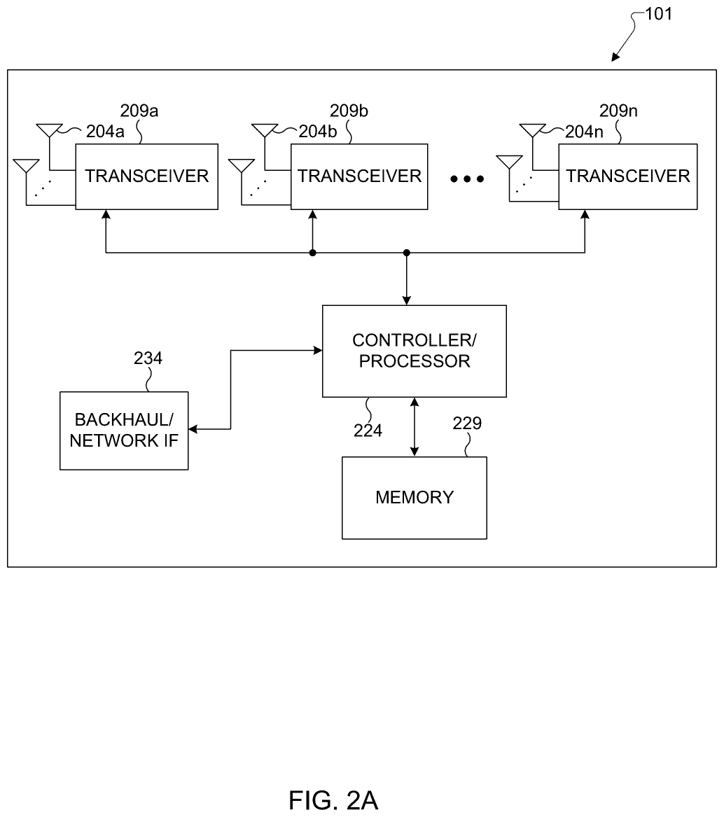

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating a framework for C-TWT. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating a framework for C-TWT. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate a framework for C-TWT. In some embodiments, the processor 240 includes at least one microprocessor or microcontroller.

The processor 240 is also capable of executing other processes and programs resident in the memory 260, such as operations for facilitating a framework for C-TWT. The processor 240 can move data into or out of the memory 260 as required by an executing process. In some embodiments, the processor 240 is configured to execute a plurality of applications 262, such as applications for facilitating a framework for C-TWT. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

In IEEE 802.11 standards, two types of TWT operation are possible-individual TWT operation and broadcast TWT operation. Individual TWT agreements can be established between two STAs or between an STA and an AP. The negotiation that takes place for an individual TWT agreement between two STAs is on an individual basis. The AP can have TWT agreements with multiple STAs. Any changes in the TWT agreement between the AP and one STA does not affect the TWT agreement between the AP and the other STA.

IEEE 802.11ax first introduced the broadcast TWT operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request for membership in the schedule or the AP can send unsolicited response to the STA to make the STA a member of the broadcast TWT schedule the AP maintains in the BSS. The AP can advertise/announce and maintain multiple broadcast TWT schedules in the network. When a change is made to any of the schedule in the network, it affects all the STAs that are members of that particular schedule.

Multi-link operation (MLO) is another feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD. TWT enhancements for multi-link devices have recently been introduced in IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, then a single TWT agreement is requested for the STA affiliated with the same MLD, which is operating on the indicated link. The Target Wake Time field of the TWT element is in reference to the TSF time of the link indicated by the TWT element. A TWT responding STA affiliated with a peer MLD that receives a TWT request that contains a Link ID Bitmap subfield in a TWT element responds with a TWT response that indicates the link(s) in the Link ID Bitmap field of a TWT element. The link(s), if present, in the TWT element carried in the TWT response, is the same as the link(s) indicated in the TWT element of the soliciting TWT request.

Restricted TWT (r-TWT) operation is another feature introduced in IEEE 802.11be standards with a view to providing better support for latency sensitive applications. Restricted TWT offers a protected service period for its member STAs by sending Quiet elements to other STAs in the BSS which are not member of the r-TWT schedule, where the Quiet interval corresponding to the Quiet element overlaps with the initial portion of the restricted TWT SP. Hence, it gives more channel access opportunity for the r-TWT member scheduled STAs, which definitely helps latency-sensitive traffic flow.

Interference from one BSS often causes performance issues for STAs and APs in nearby BSSs. This naturally results in overall throughput degradation in the network. The Overlapping BSS (OBSS) interference can also increase the overall latency since it takes more time for accessing the channel due to the interference occupying the channel. If a STA in a BSS has latency-sensitive traffic, this delay in channel access can seriously hamper the STA's latency-sensitive applications. TWT-based Multi-AP coordination can be an important feature for next-generation WLAN networks.

According to one embodiment, a first AP can coordinate with a second AP in the vicinity in order to coordinate with the first AP's individual TWT agreement, broadcast TWT schedule, or r-TWT schedule. The coordination mechanism can take different formats based on the architecture of the coordinated TWT (C-TWT) negotiation.

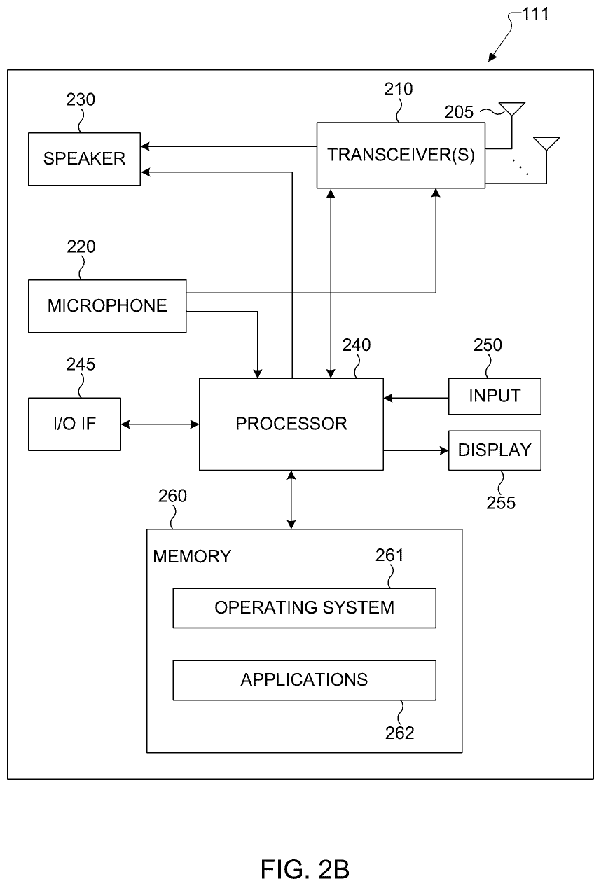

FIG. 3 illustrates an example 300 of a Type-I architecture for C-TWT negotiation according to various embodiments of the present disclosure. The embodiment of the example 300 of a Type-I architecture for C-TWT negotiation shown in FIG. 3 is for illustration only. Other embodiments of the example 300 of a Type-I architecture for C-TWT negotiation could be used without departing from the scope of this disclosure.

In Type-I architecture of coordinated TWT (C-TWT) negotiation, the APs (for example r-TWT scheduling APs) participating in the TWT multi-AP coordination can directly exchange frames within themselves to negotiate on the multi-AP TWT coordination. A Type-I architecture for coordinated TWT negotiation is illustrated in FIG. 3.

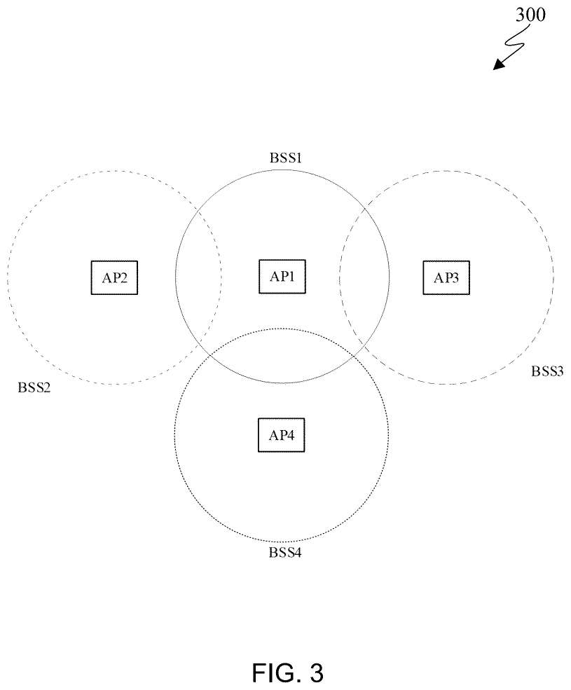

FIG. 4 illustrates an example 400 of a Type-II architecture for C-TWT negotiation according to various embodiments of the present disclosure. The embodiment of the example 400 of a Type-II architecture for C-TWT negotiation shown in FIG. 4 is for illustration only. Other embodiments of the example 400 of a Type-II architecture for C-TWT negotiation could be used without departing from the scope of this disclosure.

In Type-II architecture of coordinated TWT (C-TWT) negotiation, the APs' (for example r-TWT scheduling APs) r-TWT negotiations are controlled by an r-TWT central controller. Any kind of R-TW multi-AP negotiation are done through the central controller. A Type-II architecture for coordinated TWT negotiation is illustrated in FIG. 4.

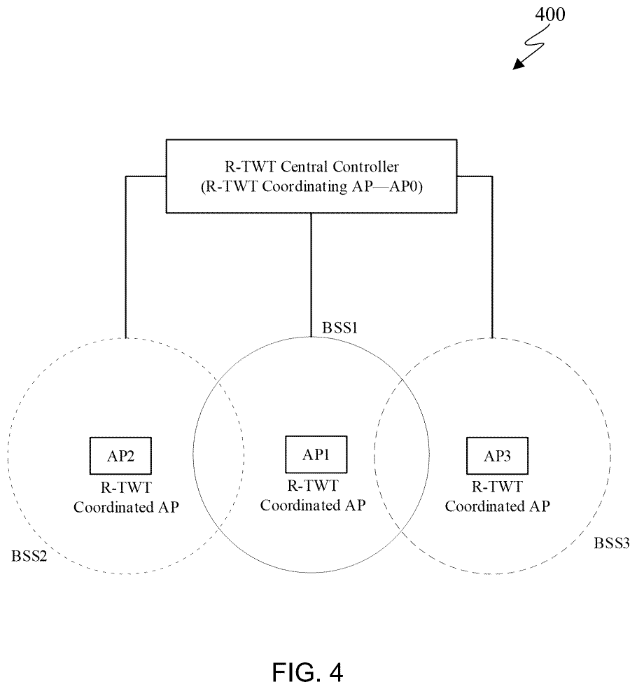

FIG. 5 illustrates an example 500 of a scenario for Mode-1 TWT-based multiple-AP coordination according to various embodiments of the present disclosure. The embodiment of the example 500 of a scenario for Mode-1 TWT-based multiple-AP coordination shown in FIG. 5 is for illustration only. Other embodiments of the example 500 of a scenario for Mode-1 TWT-based multiple-AP coordination could be used without departing from the scope of this disclosure.

According to one embodiment, in Mode-1 C-TWT, a TWT coordination among multiple APs can take place in order to assist one or more specific STAs to reduce OBSS interference towards that STA(s). This is illustrated in FIG. 5.

As illustrated in FIG. 5, AP1 controls the BSS, BSS1; AP2 controls the BSS, BSS2. STA2 is associated with AP2. However, STA2 is located at the overlapping region of the two BSS. Therefore, STA2 suffers from interference from AP1 and BSS1. In such a situation, AP1 and AP2 can coordinate with each other to establish TWT-based MAP coordination to reduce OBSS interference from STA. This type of C-TWT would be referred to as a Mode-1 C-TWT.

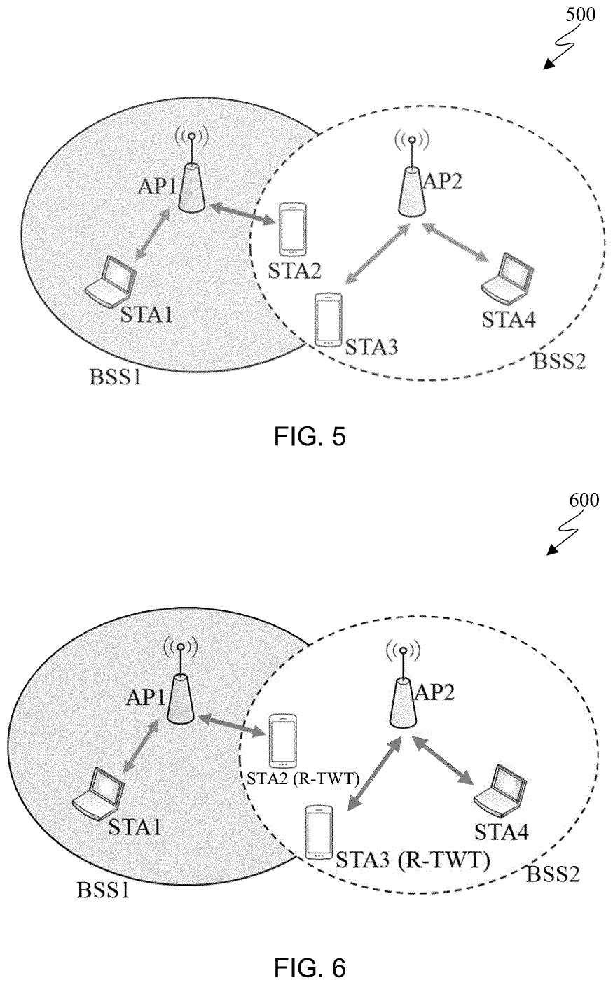

FIG. 6 illustrates an example 600 of a scenario for Mode-2 TWT-based multiple-AP coordination according to various embodiments of the present disclosure. The embodiment of the example 600 of a scenario for Mode-2 TWT-based multiple-AP coordination shown in FIG. 6 is for illustration only. Other embodiments of the example 600 of a scenario for Mode-2 TWT-based multiple-AP coordination could be used without departing from the scope of this disclosure.

According to one embodiment, in Mode-2 of C-TWT, TWT-based multi-AP coordination is established to help a group (the size of the group can be 1 or more than 1) of STAs' TWT protection. Such C-TWT may not be specific for assisting any specific STA in the network. This is illustrated in FIG. 6.

As illustrated in FIG. 6, AP1 controls the BSS, BSS1; AP2 controls the BSS, BSS2. STA2 and STA3 are associated with AP2. Both the STA2 and STA3 are r-TWT scheduled STAs and are members of a first r-TWT schedule. AP2 can request to AP1 for protection of the first r-TWT schedule. Such protection can be, for example, by terminating any TXOP in BSS1 before the start time of the SP corresponding to the first r-TWT schedule.

According to one embodiment, if a first STA is associated with a first AP and is a member of TWT schedule or TWT agreement, if the first STA suffers from OBSS interference from a second AP's BSS, then the first AP can send a TWT coordination request to the second AP in order to reduce interference towards the first STA. In the TWT coordination request, the first AP can indicate the mode of coordination of C-TWT. Along with the mode of C-TWT, other information can also be included in the coordination request, such as:
1. Form of coordination requested during the indicated TWT schedule or agreement: coordination beamforming, joint transmission, coordinated spatial reuse, TXOP termination (e.g., for r-TWT) etc.
2. Time duration: How long the coordination would be needed.

According to one embodiment, if a first STA is associated with a first AP and is a member of the TWT schedule or TWT agreement, if the first STA suffers from OBSS interference from a second AP's BSS, and if the first AP sends a TWT coordination request to the second AP in order to reduce interference towards the first STA, then the second AP can send a response to the first AP indicate the acceptance/rejection/alternate suggestion of the coordination request from the first AP.

According to one embodiment, in Mode-1's C-TWT, if a first STA is associated with a first AP and is a member of the TWT schedule or TWT agreement, if the first STA suffers from OBSS interference from a second AP's BSS, then—
the first STA can request the first AP to initiate a TWT-based multi AP coordination with the second AP to protected the first STA's TWT schedule or agreement.
the first STA can request the second AP to initiate to protected the first STA's TWT schedule or agreement.

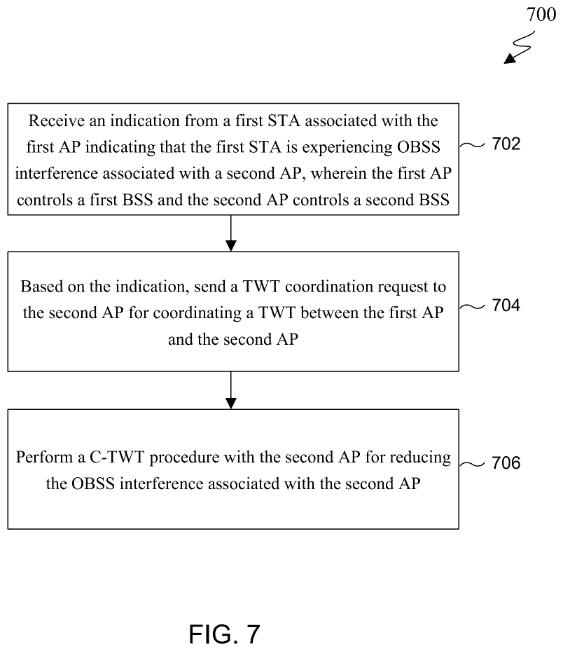

FIG. 7 illustrates a flow diagram of a method 700 for wireless communication performed by an AP device according to embodiments of the present disclosure. The example method 700 shown in FIG. 7 is for illustration only. Other embodiments of the example method 700 could be used without departing from the scope of this disclosure.

As illustrated in FIG. 7, the method 700 begins at step 702, where the AP receives an indication from a first STA associated with the first AP indicating that the first STA is experiencing OBSS interference associated with a second AP, wherein the first AP controls a first BSS and the second AP controls a second BSS. At step 704, based on the indication, the AP device sends a TWT coordination request to the second AP for coordinating a TWT between the first AP and the second AP. At step 706, the AP device performs a coordinated TWT (C-TWT) procedure with the second AP for reducing the OBSS interference associated with the second AP.

In one embodiment, the TWT coordination request includes an indication of a mode of coordination of the C-TWT procedure, the mode of coordination comprising: a first mode of coordination associated with reducing the OBSS interference associated with the second AP towards one or more specific STAs in the BSS of the first AP; or a second mode of coordination associated with reducing the OBSS interference associated with the second AP towards one or more non-specific STAs that form a group of STAs in the BSS of the first AP.

In one embodiment, the first STA is a member of a TWT schedule, and the TWT coordination request further comprises a form of coordination requested during the TWT schedule.

In one embodiment, the form of coordination requested during the TWT schedule comprises one or more of coordination beamforming, joint transmission, coordinated spatial reuse, and TXOP termination.

In one embodiment, the first STA is a member of a TWT schedule, and the TWT coordination request further comprises a time duration of TWT coordination.

In one embodiment, the first STA is a member of a TWT schedule, and the AP device receives a response from the second AP that accepts, rejects, or is an alternative to the TWT coordination request.

In one embodiment, the mode of coordination comprises the first mode of coordination, the first STA is a member of a TWT schedule, and the indication from the first STA includes a request to initiate coordination of the TWT between the first AP and the second AP to protect the TWT schedule of the first STA.

In one embodiment, the mode of coordination comprises the first mode of coordination, the first STA is a member of a TWT schedule, and the method further comprises receiving a request from the second AP to protect the TWT schedule of the first STA.

In one embodiment, the mode of coordination comprises the second mode of coordination, one or more STAs including the first STA is a member of a same restricted TWT (r-TWT) schedule, and the TWT coordination request further comprises a request to protect the r-TWT schedule of the one or more STAs.

In one embodiment, the request to protect the r-TWT schedule of the one or more STAs further comprises a request to terminate a transmission opportunity (TXOP) in the BSS of the second AP before a start time of a service period (SP) corresponding to the r-TWT schedule of the one or more STAs.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first access point (AP), the method comprising:
receiving an indication from a first station (STA) associated with the first AP indicating that the first STA is experiencing overlapping basic service set (OBSS) interference associated with a second AP, wherein the first AP controls a first basis service set (BSS) and the second AP controls a second BSS;
based on the indication, sending a target wake time (TWT) coordination request to the second AP for coordinating a TWT between the first AP and the second AP; and
performing a coordinated TWT (C-TWT) procedure with the second AP for reducing the OBSS interference associated with the second AP.

2. The method of claim 1, wherein the TWT coordination request includes an indication of a mode of coordination of the C-TWT procedure, the mode of coordination comprising:
a first mode of coordination associated with reducing the OBSS interference associated with the second AP towards one or more specific STAs in the BSS of the first AP; or
a second mode of coordination associated with reducing the OBSS interference associated with the second AP towards one or more non-specific STAs that form a group of STAs in the BSS of the first AP.

3. The method of claim 2, wherein:
the first STA is a member of a TWT schedule, and
the TWT coordination request further comprises a form of coordination requested during the TWT schedule.

4. The method of claim 3, wherein the form of coordination requested during the TWT schedule comprises one or more of coordination beamforming, joint transmission, coordinated spatial reuse, and transmission opportunity (TXOP) termination.

5. The method of claim 2, wherein:
the first STA is a member of a TWT schedule, and
the TWT coordination request further comprises a time duration of TWT coordination.

6. The method of claim 2, wherein:
the first STA is a member of a TWT schedule, and
performing the C-TWT procedure comprises receiving a response from the second AP that accepts, rejects, or is an alternative to the TWT coordination request.

7. The method of claim 2, wherein:
the mode of coordination comprises the first mode of coordination,
the first STA is a member of a TWT schedule, and
the indication from the first STA includes a request to initiate coordination of the TWT between the first AP and the second AP to protect the TWT schedule of the first STA.

8. The method of claim 2, wherein:
the mode of coordination comprises the first mode of coordination,
the first STA is a member of a TWT schedule, and
the method further comprises receiving a request from the second AP to protect the TWT schedule of the first STA.

9. The method of claim 2, wherein:
the mode of coordination comprises the second mode of coordination,
one or more STAs including the first STA is a member of a same restricted TWT (r-TWT) schedule, and
the TWT coordination request further comprises a request to protect the r-TWT schedule of the one or more STAs.

10. The method of claim 9, wherein the request to protect the r-TWT schedule of the one or more STAs further comprises a request to terminate a transmission opportunity (TXOP) in the BSS of the second AP before a start time of a service period (SP) corresponding to the r-TWT schedule of the one or more STAs.

11. A first access point (AP) comprising:
a transceiver; and
a processor operably coupled to the transceiver, the processor configured to:
receive an indication from a first station (STA) associated with the first AP indicating that the first STA is experiencing overlapping basic service set (OBSS) interference associated with a second AP, wherein the first AP controls a first basis service set (BSS) and the second AP controls a second BSS;
based on the indication, send a target wake time (TWT) coordination request to the second AP for coordinating a TWT between the first AP and the second AP; and
perform a coordinated TWT (C-TWT) procedure with the second AP for reducing the OBSS interference associated with the second AP.

12. The first AP of claim 11, wherein the TWT coordination request includes an indication of a mode of coordination of the C-TWT procedure, the mode of coordination comprising:
a first mode of coordination associated with reducing the OBSS interference associated with the second AP towards one or more specific STAs in the BSS of the first AP; or
a second mode of coordination associated with reducing the OBSS interference associated with the second AP towards one or more non-specific STAs that form a group of STAs in the BSS of the first AP.

13. The first AP of claim 12, wherein:
the first STA is a member of a TWT schedule, and
the TWT coordination request further comprises a form of coordination requested during the TWT schedule.

14. The first AP of claim 13, wherein the form of coordination requested during the TWT schedule comprises one or more of coordination beamforming, joint transmission, coordinated spatial reuse, and transmission opportunity (TXOP) termination.

15. The first AP of claim 12, wherein:
the first STA is a member of a TWT schedule, and
the TWT coordination request further comprises a time duration of TWT coordination.

16. The first AP of claim 12, wherein:
the first STA is a member of a TWT schedule, and
to perform the C-TWT procedure, the processor is configured to receive a response from the second AP that accepts, rejects, or is an alternative to the TWT coordination request.

17. The first AP of claim 12, wherein:
the mode of coordination comprises the first mode of coordination,
the first STA is a member of a TWT schedule, and
the indication from the first STA includes a request to initiate coordination of the TWT between the first AP and the second AP to protect the TWT schedule of the first STA.

18. The first AP of claim 12, wherein:
the mode of coordination comprises the first mode of coordination,
the first STA is a member of a TWT schedule, and
the processor is further configured to receive a request from the second AP to protect the TWT schedule of the first STA.

19. The first AP of claim 12, wherein:
the mode of coordination comprises the second mode of coordination,
one or more STAs including the first STA is a member of a same restricted TWT (r-TWT) schedule, and
the TWT coordination request further comprises a request to protect the r-TWT schedule of the one or more STAs.

20. The first AP of claim 19, wherein the request to protect the r-TWT schedule of the one or more STAs further comprises a request to terminate a transmission opportunity (TXOP) in the BSS of the second AP before a start time of a service period (SP) corresponding to the r-TWT schedule of the one or more STAs.
